(19) United States
(12) Patent Application Publication
(10) Pub. No.: US 2002/0169881 A1
(43) Pub. Date: Nov. 14, 2002

(54) Method and apparatus for distributed access to services in a network data processing system

(75) Inventors: Kirk Fritsche, Cedar Park, TX (US); Mark David Nielsen, Houston, TX (US); Patrick Edward Nogay, Austin, TX (US); Michael Albert Perks, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/852,604

(22) Filed: May 10, 2001

(51) Int. Cl. G06F 15/16; G06F 15/173

(52) U.S. Cl. 709/229; 709/225

(57) ABSTRACT

A method, apparatus, and computer implemented instructions for accessing a client service in a data processing system. A pool of client services is managed by a server abstraction. A client service instance is assigned from the pool of client services in response to a request from a user application from a plurality of user applications. The user application request on the client service is invoked by the server abstraction. The result from the server service is returned to the user application by client service instance.

### BACKGROUND OF THE INVENTION

1. Technical Field

The present invention relates generally to an improved data processing system, and in particular to a method and apparatus for accessing services. Still more particularly, the present invention provides a method, apparatus, and computer implemented instructions for distributed access of services in a network data processing system.

2. Description of Related Art

In a conventional computer network, a number of clients are in communication with each other and one or more server computers, which store data and programs accessed by the client. This architecture is also referred to as a client/server environment. With this type of architecture the client processes the user interface and can perform some or all of the application processing. Servers range in capacity from high-end PCs to mainframes. A database server maintains the databases and processes requests from the client to extract data from or to update the database. In some cases, the server also will include processes used to handle data in response to requests from the client.

In two-tier client/server architecture, a file server performs the application and database processing. A request is generated in the client and transmitted to the server. The database management service searches for records in the server and returns only matching records to the client. If 50 records met the criteria in our 100,000-record example, only 50K would be transmitted over the local area network (LAN). In three-tier client/server, the processing is divided between two or more servers, one typically used for application processing and another for database processing.

With the increasing use of the World Wide Web by users and businesses, services traditionally found on LANs are now also being provided across the World Wide Web. The World Wide Web is also referred to as just the “Web”. Many clients use programs known as “applets”, which may be embedded as objects in HTML documents on the Web. Applets are Java programs that may be transparently downloaded into a browser supporting Java along with HTML pages in which they appear. These Java programs are network and platform independent. Applets run the same way regardless of where they originate or what data processing system onto which they are loaded. Java is an object oriented programming language and environment focusing on defining data as objects and the methods that may be applied to those objects. Java supports only a single inheritance, meaning that each class can inherit from only one other class at any given time. Java also allows for the creation of totally abstract classes known as interfaces, which allow the defining of methods that may be shared with several classes without regard for how other classes are handling the methods. Java provides a mechanism to distribute software and extends the capabilities of a Web browser because programmers can write an applet once and the applet can be run on any Java enabled machine on the Web.

One problem arising out of the increased motivation to provide e-business Web-based applications, is the requirement to wrapper or reuse existing applications that were not designed for the Internet. For example, the e.Reporting Suite 5 is a report writing system available from Actuate Corporation for generating reports. Although it can provide Web-based reports for multiple clients, it does not have the ability to be run as a back-end process responding to client requests via an application server. In this case the application server may provide enhanced capability such as transactions and report data manipulation.

e.Reporting Suite 5 provides access to the report server services through a single-threaded application programming interface (API) in the C language. Although Java can wrap this API, the support provided by this API limits the execution of report requests to one request at a given time. Therefore, all report requests to the application server are restricted to this very narrow single-threaded connection to the report services for this system.

Therefore, it would be advantageous to have an improved method and apparatus for accessing services in a network data processing system.

### SUMMARY OF THE INVENTION

The present invention provides a method, apparatus, and computer implemented instructions for simultaneous access of a single-threaded client service in a data processing system. A server abstraction layer manages a pool of client services. A client service is assigned from the pool of client services in response to a request from a user application from a plurality of user applications. The assignment of the request to the client service results in the invocation of the server service. The result from the server service is returned to the user application via the client service and server abstraction layer.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a message flow diagram for processing a report request from multiple clients without an application server;

FIG. 5 is a message flow diagram for processing multiple report requests using an application server;

FIG. 6 is a message flow diagram illustrating request processing in accordance with a preferred embodiment of the present invention;

FIG. 7 is a diagram of components used in providing access to server processes in accordance with a preferred embodiment of the present invention; and

FIG. 8 is a flowchart of a process used for handling requests for services in accordance with a preferred embodiment of the present invention.

### DETAILED DESCRIPTION OF THE PREFERRED EMBODIMENT

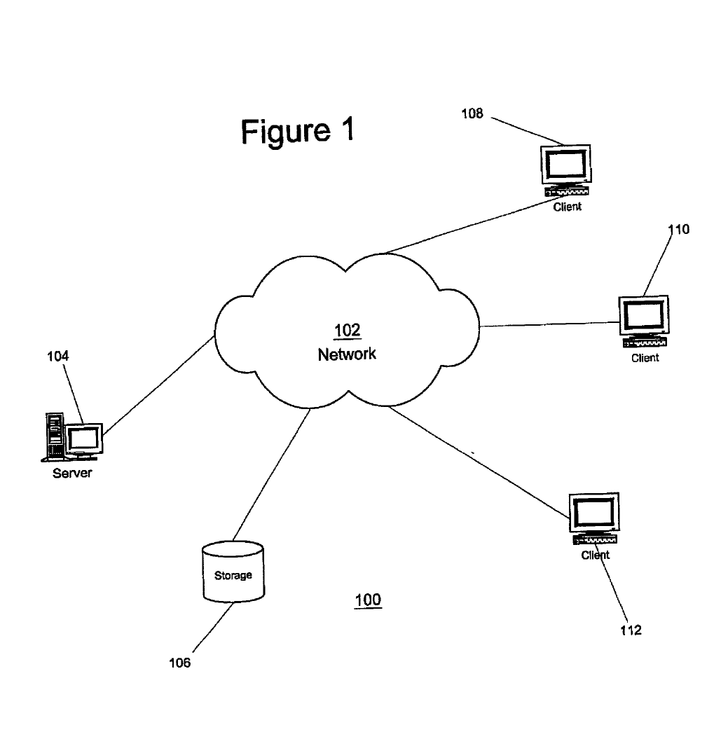

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. In this example, clients 108, 110, and 112 may include processes, such as report writing processes, that access information or other processes on a server, such as server 104. The present invention provides a method, apparatus, and computer implemented instructions for a multi-threaded access to services, which are single-threaded. This mechanism includes a server, which manages a set of active connections in which these connections are used for sending requests and receiving results. The server tracks each request and the state of the request from the creation of the request through the return of the result. Network data processing system 100 may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

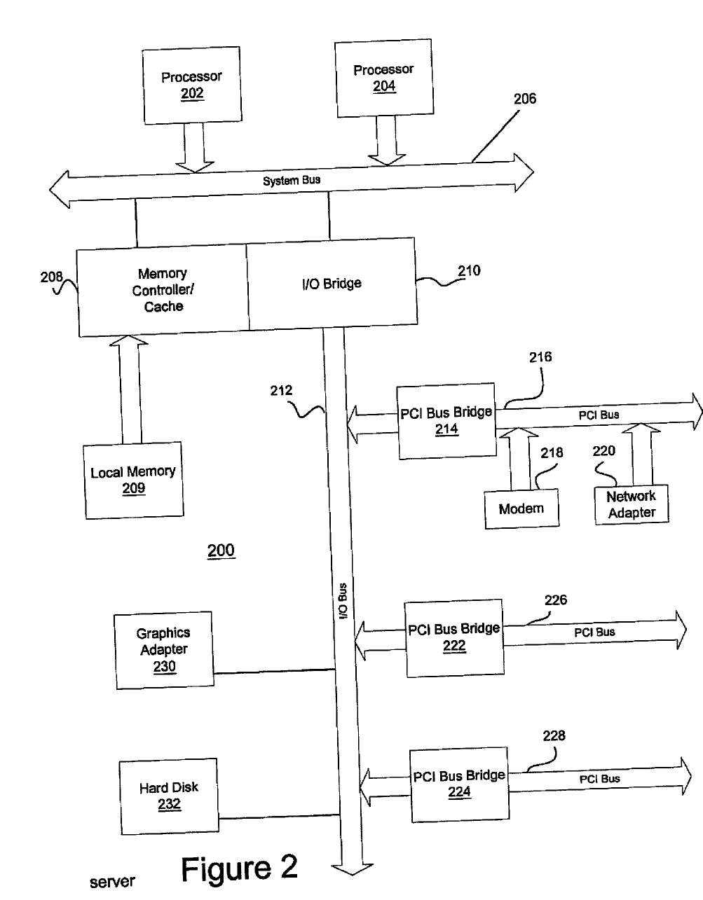

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

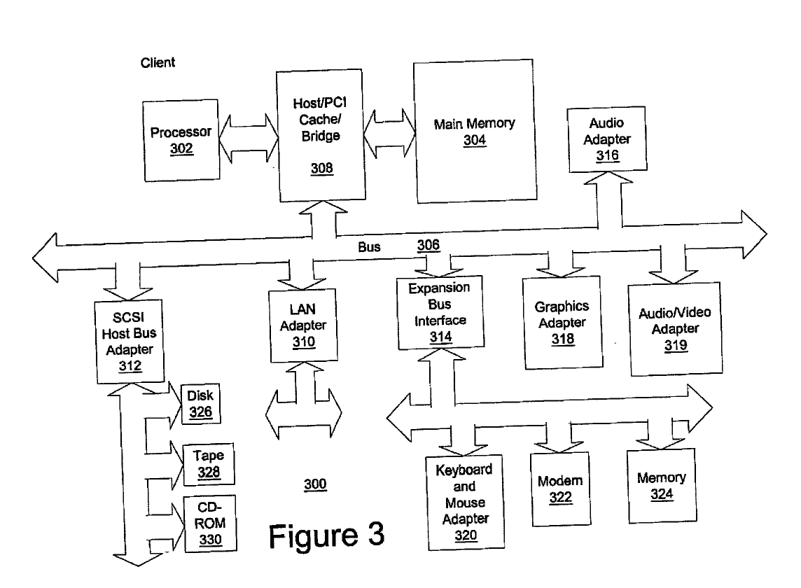

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

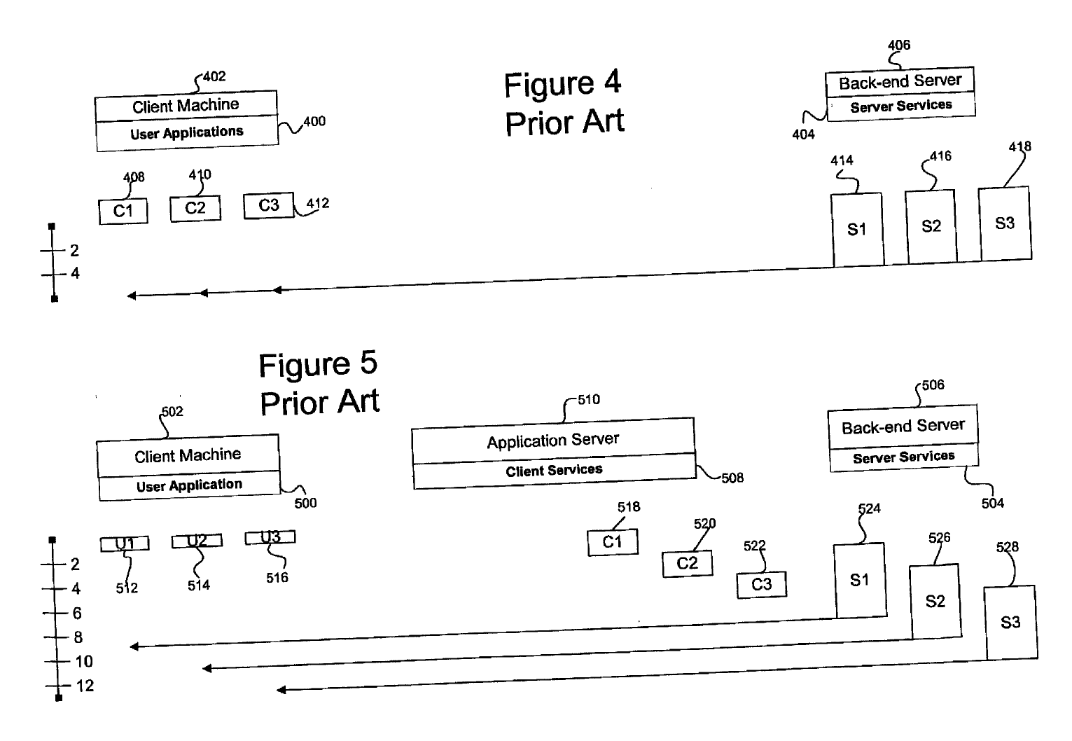

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance. With reference now to FIG. 4, a message flow diagram for processing report requests is illustrated for a currently known report service. This diagram is provided to illustrate processing of requests for reports at a backend server.

In this example, in FIG. 4, a client/server message flow is illustrated in which an application server is absent. In this example, three separate user applications 400 on client machine 402 each desire to submit a request for server services 404 on backend server 406 to generate reports. In this example, user application 400 submits request C1 408, request C2 410, and request C3 412 to server services 404. Server services 404 returns result S1 414, result S2 416, and result S3 418 back to user application 400 after six units of time have elapsed. In this particular example, server services 404 is able to process all of the requests at the same time.

With reference now to FIG. 5, a message flow diagram for processing report requests is illustrated for a currently known report service. This diagram is provided to illustrate the sequential nature of request submission required with a single-threaded client service process at an application server.

User application 500 in client machine 502 generates requests for processing by server services 504 in backend server 506. These requests are handled by the application server 510 and passed to the single-threaded client services 508 in application server 510. In particular, user application 500 begins by generating request U1 512, request U2 514, and request U3 516. These requests are generated at a first time unit and are received at application server 510. Multiple users of the application or a single user of the application may generate the requests. Client services 508 is only able to handle only one request at a time. Application server 510 is multi-threaded and able to receive these requests, but processing of the requests is slowed down by client services 508.

Upon receiving request U1 512 at client services 508, request C1 518 is sent to server services 504 for processing. In sending request C1 518 to server services 504, client services 508 establishes a connection to server services 504, sends request C1 518, and then closes the connection. As a result, a wait time of two units is required before request C2 520 may be submitted by user application 500 to server services 504. In sending request C2 520 a connection is opened and closed with server services 504. Client services 508 waits for another two units of time before sending request C3 522 to server services 504. A similar establishment and termination of a connection with server services 504 is required to send request C3 522.

Server services 504 is a multi-threaded process in this example. Server services 504 returns result S1 524 after nine units of time have elapsed from user application 500 sending requests for reports. Result S2 526 is returned after eleven units of time have elapsed from user application 500 sending requests for report. Result S3 528 is returned to user application 500 after thirteen units of time have elapsed.

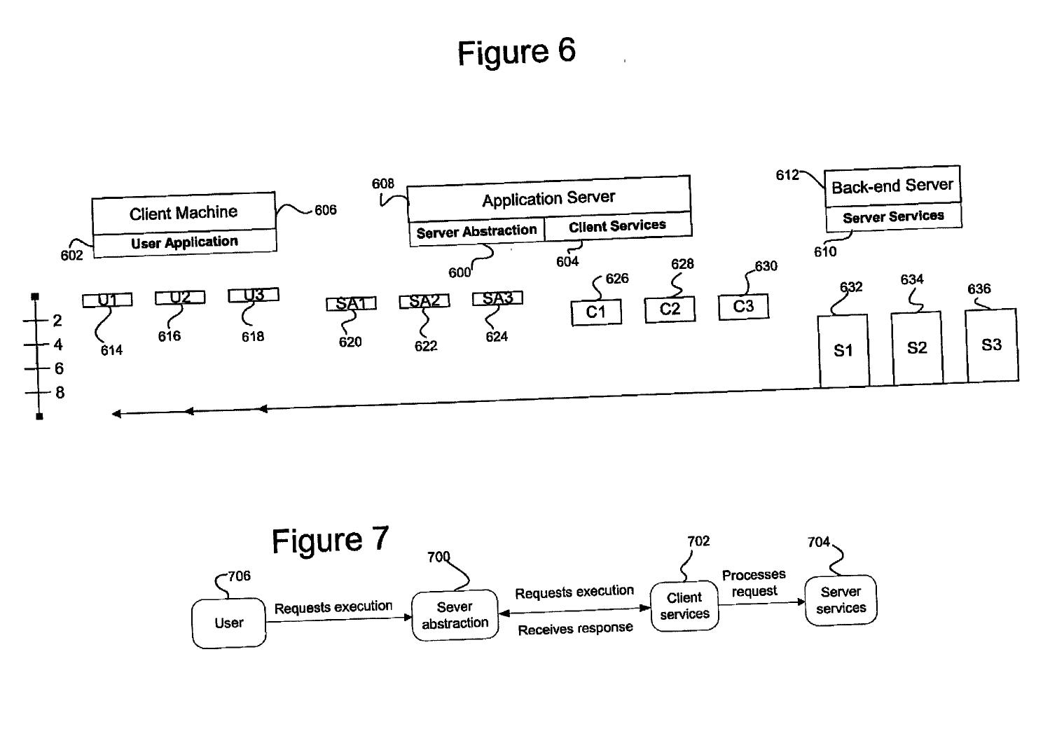

Turning next to FIG. 6, a message flow diagram illustrating request processing is depicted in accordance with a preferred embodiment of the present invention. The message flow diagram in FIG. 6 illustrates processing using a server abstraction mechanism of the present invention.

In this example, server abstraction 600 is provided as an interface between user application 602 and client services 604. Client services 604 is similar to client services 508 in FIG. 5 in which this client service is a single-threaded API. In this example, however, client services 604 opens or establishes a connection to server services 610 and leaves the connection open to process multiple requests, which may originate from different user applications or different client machines. Server abstraction 600 is multi-threaded. It manages a pool of client service processes to send requests and receive results from the server services.

In this example, user application 602 is located in client machine 606. Server abstraction 600 and client services 604 are located in application server 608. Server services 610 in backend server 612 generates reports in response to requests from user application 602. These requests are handled by server abstraction 600 and client services 604.

User application 602 generates request U1 614, request U2 616 and request U3 618. These requests may be generated by different applications on client machine 606 or even from applications on different client machines. In this example, these requests are generated at the first unit of time. A set or pool of processes are maintain by server abstraction 600 to handle requests from applications. In the depicted examples, server abstraction thread S1 620, server abstraction thread S2 622, and server abstraction thread S3 624 are assigned to request U1 614, request U2 616 and request U3 618, respectively. Each server abstraction thread handles a request by allocating a client service process from the pool of client service processes in client services 604. If no free client service processes are available in the pool, then server abstraction 600 can either wait and eventually time out or return an error to user application 602. Client services 604 then handles sending the request to server service 610 and returning the result via server abstraction 600 to user application 602. Client services 604 generates request C1 626, request C2 628, and request C3 630 based on calls from server abstraction thread S1 620, server abstraction thread S2 622, and server abstraction thread S3 624. These requests are sent to server services 610 during the third unit of time by each corresponding client service process assigned to request C1 626, request C2 628, and request C3 630. Server services 610 returns result S1 632, result S2 634, and result S3 636 to user application 602 after ten units of time have passed.

As can be seen, the user of server abstraction 600 provides an advantage over the known mechanism of having a user application send requests directly to client services on an application server. In particular, an advantage in gained in reducing the overhead and time needed to open and close connections to server services. The mechanism of the present invention opens the connection the first time a request is received and keeps that connection open for other requests.

With reference now to FIG. 7, a diagram of components used in providing access to server processes is depicted in accordance with a preferred embodiment of the present invention. In this example, server abstraction 700 and client services 702 may be found on a application server, such as server 104 in FIG. 1. Server services 704 may be implemented in a server, such as server 104 in FIG. 1. User application 706 generates a request for execution of a process at server services 704. This request is sent to server abstraction 700, which requests the execution of these services through client services 702. The requesting of the execution of the services is handled by a process from a set or pool of processes assigned to the request. Client services 702 initiates processing of this request by server services 704. Additionally, server abstraction 700 also receives the response returned by client services 702 and relays this information back to user application 706.

Server abstraction 700 manages requests from user application 706 and a pool or set of connections to client services 702. These pooled connections are used only for the short duration of time for sending the requests and again for receiving the results. Because each client service is single-threaded, it normally runs in its own process. The server abstraction is responsible for starting these processes and allocating a free process from the pool to an individual user application request. The connections managed by server abstraction 700 are maintained while server abstraction 700 is active. In other words, the establishment and termination of a connection by client services 702 to server services 704 each time a request is made is avoided.

Server abstraction 700 tracks each request and the state of each request from the creation of the request through the returning of the results in response to the request. Server abstraction 700 is necessary for management of incoming requests, ensuring that resources are available, and providing for queuing of requests. Additionally, results may by queued or stored prior to being returned to the requester, such as user application 706. In this manner, specific knowledge of how to access client services 702 in not required by the user application 706 with this system.

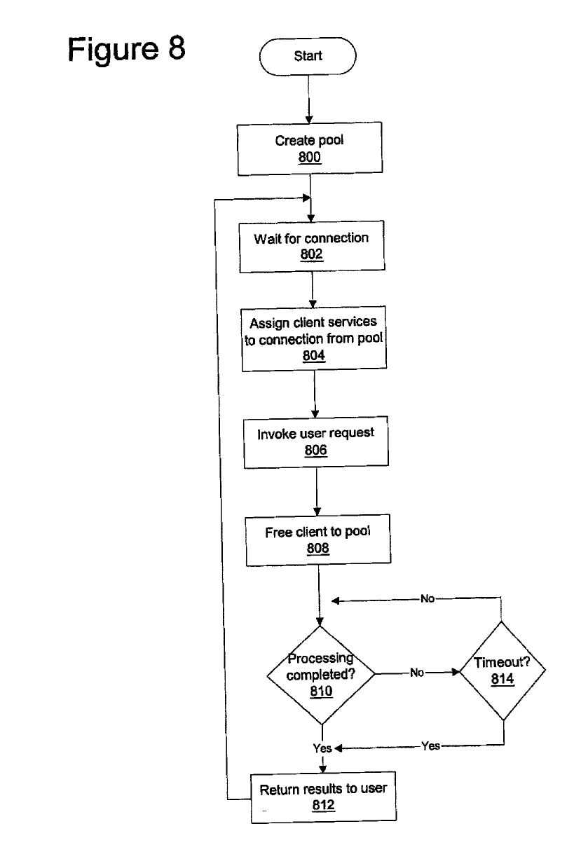

Turning next to FIG. 8, a flowchart of a process used for handling requests for services is depicted in accordance with a preferred embodiment of the present invention. The process illustrated in FIG. 8 may be implemented in a server abstraction, such as server abstraction 700 in FIG. 7.

The process begins by creating a pool (step 800). The pool is set of connections to the client services. The client services, in these examples, are single-threaded API. Of course, the mechanism of the present invention may be applied to other types of client services other than a single-threaded API. Next, the process waits for a connection from a user application (step 802). A client services instance is assigned from the pool to the user application connection (step 804). Then, a user request is invoked using the connection (step 806). The user request may be a request obtained from a queue of requests if a number of requests have been received, but have not yet been sent to the client services for processing. The client service instance is freed to the pool (step 808). If the server services 704 in FIG. 7 cannot respond asynchronously back to the server abstraction 700, then the client service instance cannot be returned to the pool until the request has completed or timed out.

Next, a determination is then made as to whether a response from the server services has been received either through an asynchronous or synchronous mechanism (step 810). If a response is received, the results are returned to the user (step 812) and the process returns to step 802 as described above. In step 812, the results are returned to user application 706 in FIG. 7. Otherwise, a determination is made as to whether a timeout has occurred (step 814). If a timeout has occurred, the process returns to step 812 and an error result is returned to the user application 706. If no timeout has occurred, the process returns to step 812 as described above.

Thus, the present invention provides an improved method, apparatus, and computer implemented instructions for accessing services. In particular, the mechanism allows for multi-threaded access to services in which a single-threaded process, such as an API is provided as the interface. This mechanism reduces connection management required by a user. Additionally, fewer resources are needed with connection reuse. The access to services, such as report facilities, is made from a central and simplified access point for distributed applications, such as Java applications.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for accessing a client service, the method comprising:
managing a pool of connections to the client service;
responsive to a request from a user application from a plurality of user applications, assigning a client service from the pool of client service instances;
invoking the request on the client; and
responsive to receiving a response from the client service, returning the result to the user application.

2. The method of claim 1 further comprising:
freeing the client service back to the pool after invoking the request on the client service.

3. The method of claim 1 further comprising:
waiting for the response from the client service after the client service has been invoked; and
responsive to a timeout occurring while waiting for the response, returning a response to the user indicating that the timeout has occurred.

4. The method of claim 1, wherein the user application is a client application.

5. The method of claim 1, wherein the client service is an application programming interface to a server process.

6. The method of claim 5, wherein the server process is located on a remote data processing system.

7. The method of claim 1, wherein the pool of client services is used to access report services on a server.

8. The method of claim 1, wherein the response is returned immediately upon receiving the response.

9. The method of claim 1, wherein a error message is returned to the user application after a period of time passes without receiving the response.

10. The method of claim 1 further comprising:
placing the request in a queue if there are no free client services within the pool of client services.

11. The method of claim 1, wherein a particular client service instance only accepts and processes one request at a time.

12. The method of claim 10, wherein the server service is located on a remote data processing system.

13. A method in a data processing system for accessing a client service, the method comprising:
receiving requests for the client service, wherein the client service is a single-threaded process;
queuing a new request if a current request has been invoked on the client service;
responsive to receiving a response to the current request from the client service, returning the result to a requester of the current request; and
invoking the new request on the client service.

14. The method of claim 13, wherein requests are sent to the client service form the queue in a first-in-first-out basis.

15. The method of claim 13, wherein the client service is used to access a server process in a server.

16. The method of claim 13, wherein the client service is an application programming interface to a server process.

17. A data processing system comprising:
a bus system;
a communications unit connected to the bus system;
a memory connected to the bus system, wherein the memory includes as set of instructions; and
a processing unit connected to the bus system, wherein the processing unit executes the set of instructions to manage a pool of connections to the client service; assign a connection from the pool of connections to the client service in response to a request from a client from a plurality of clients; invoke the request on the client service using the connection; and return the result to the user in response to receiving a response from the client service.

18. A data processing system comprising:
a bus system;
a communications unit connected to the bus system;
a memory connected to the bus system, wherein the memory includes as set of instructions; and
a processing unit connected to the bus system, wherein the processing unit executes the set of instructions to receive requests for the client service, wherein the client service is a single-threaded process; queue a new request if a current request has been invoked on the client service; return the result to a requestor of the current request in response to receiving a response to the current request from the client service; and invoke the new request on the client service.

19. A data processing system for accessing a client service, the data processing system comprising:
managing means for managing a pool of connections to the client service;
assigning means, responsive to a request from a user application from a plurality of user applications, for assigning a client service from the pool of client service instances;
invoking means for invoking the request on the client; and
returning means, responsive to receiving a response from the client service, for returning the result to the user application.

20. The data processing system of claim 19 further comprising:
freeing means for freeing the client service back to the pool after invoking the request on the client service.

21. The data processing system of claim 19 further comprising:
waiting means for waiting for the response from the client service after the client service has been invoked; and
responsive to a timeout occurring while waiting for the response, returning a response to the user indicating that the timeout has occurred.

22. The data processing system of claim 19, wherein the user application is a client application.

23. The data processing system of claim 19, wherein the client service is an application programming interface to a server process.

24. The data processing system of claim 23, wherein the server process is located on a remote data processing system.

25. The data processing system of claim 19, wherein the pool of client services is used to access report services on a server.

26. The data processing system of claim 19, wherein the response is returned immediately upon receiving the response.

27. The data processing system of claim 19, wherein a error message is returned to the user application after a period of time passes without receiving the response.

28. The data processing system of claim 19 further comprising:
placing means for placing the request in a queue if there are no free client services within the pool of client services.

29. The data processing system of claim 19, wherein a particular client service instance only accepts and processes one request at a time.

30. The data processing system of claim 27, wherein the server service is located on a remote data processing system.

31. A data processing system for accessing a client service, the data processing system comprising:
receiving means for receiving requests for the client service, wherein the client service is a single-threaded process;
queuing means for queuing a new request if a current request has been invoked on the client service;
returning means, responsive to receiving a response to the current request from the client service, for returning the result to a requestor of the current request; and
invoking means for invoking the new request on the client service.

32. The data processing system of claim 31, wherein requests are sent to the client service form the queue in a first-in-first-out basis.

33. The data processing system of claim 30, wherein the client service is used to access a server process in a server.

34. The data processing system of claim 30, wherein the client service is an application programming interface to a server process.

35. A computer program product in a computer readable medium for accessing a client service, the computer program product comprising:
first instructions for managing a pool of connections to the client service;
second instructions, responsive to a request from a user application from a plurality of user applications, for assigning a client service from the pool of client service instances;
third instructions for invoking the request on the client; and
fourth instructions, responsive to receiving a response from the client service, for returning the result to the user application.

36. A computer program product in a computer readable medium for accessing a client service, the computer program product comprising:
first instructions for receiving requests for the client service, wherein the client service is a single-threaded process;
second instructions for queuing a new request if a current request has been invoked on the client service;
third instructions, responsive to receiving a response to the current request from the client service, for returning the result to a requester of the current request; and
fourth instructions for invoking the new request on the client service.
